(19) United States
(12) Patent Application Publication
(10) Pub. No.: US 2007/0026311 A1
(43) Pub. Date: Feb. 1, 2007

(54) BATTERY

(75) Inventors: Yoshiaki Obana, Tokyo (JP); Takashi Tokunaga, Tokyo (JP); Hiroyuki Akashi, Tokyo (JP)

Correspondence Address: BELL, BOYD & LLOYD, LLC, P. O. BOX 1135, CHICAGO, IL, 60690-1135, US

(73) Assignee: SONY CORPORATION, Tokyo (JP)

(21) Appl. No.: 11/459,514

(22) Filed: Jul. 24, 2006

(30) Foreign Application Priority Data
Jul. 29, 2005 (JP) 2005-222195
May 22, 2006 (JP) 2006-141036

(51) Int. Cl. H01M 4/62; H01M 4/52; H01M 10/40

(52) U.S. Cl. 429/217; 429/231.3; 429/223; 429/221; 429/231.5; 429/220; 429/229; 429/231.6; 429/338

(57) ABSTRACT

A battery capable of improving the charge and discharge efficiency even when the battery voltage is set to over 4.2 V is provided. A cathode and an anode are oppositely arranged with an electrolyte and a separator in between. The open circuit voltage in full charge is in the range from 4.25 V to 6.00 V. The cathode has a cathode current collector and a cathode active material layer provided on the cathode current collector. The cathode active material layer contains, as a binder, a polymer with intrinsic viscosity of 2.0 dl/g to 10 dl/g which contains vinylidene fluoride as an element.

### CROSS REFERENCES TO RELATED APPLICATIONS

The present application claims priority to Japanese Patent Application JP 2005-222195 filed in the Japanese Patent Office on Jul. 29, 2005 and Japanese Patent Application JP 2006-141036 filed in the Japanese Patent Office on May 22, 2006, the entire contents of which are being incorporated herein by references.

### BACKGROUND

The present invention generally relates to a battery. More specifically, the present invention relates to a battery using a cathode which contains a binder.

In recent years, portable information electronic devices such as mobile phones, video cameras, and notebook computers become common. Accordingly, technical advantages, downsizing, and weight saving of the devices have been rapidly developed. As a power source used for the devices, disposable primary batteries and repeatedly usable secondary batteries are used. From the viewpoint of favorable comprehensive balance among the economical efficiency, the high performance, the small size, and the light weight, secondary batteries, in particular lithium ion secondary batteries have been increasingly demanded. Further, in the portable information electronic devices, technical advantages and downsizing have been further promoted. Therefore, a higher energy density has been demanded for the lithium ion secondary batteries.

For attaining the high energy density, it is important to use a cathode with a high discharge capacity per unit volume. For example, it has been considered to use various cathode active materials.

In the existing lithium ion secondary batteries, lithium cobaltate is used for the cathode, a carbon material is used for the anode, and the charging final voltage is from 4.1 V to 4.2 V. In the lithium ion secondary battery in which the charging final voltage is designed as above, for the cathode active material such as lithium cobaltate used for the cathode, only about 50% to 60% of the capacity to the theoretical capacity is utilized. Therefore, in principle, it is possible to utilize the remaining capacity by further increasing the charging voltage. In reality, it is known that a high energy density is realized by setting the voltage in charge to 4.30 V or more (for example, refer to International Publication No. WO03/0197131).

However, when a charging voltage is increased, oxidation atmosphere in the vicinity of the cathode is intensified, and contact characteristics between a cathode active material layer and a cathode current collector are lowered. Therefore, there has been a disadvantage that the contact area between the cathode active material, an electrical conductor, and the cathode current collector is decreased, and thus the electron transfer resistance is increased and the charge and discharge efficiency is lowered.

### SUMMARY

In view of the foregoing, it is desirable to provide a battery which can improve the charge and discharge efficiency even when the battery voltage is set to over 4.2 V.

According to an embodiment, there is provided a battery, in which a cathode and an anode are oppositely arranged with an electrolyte and a separator in between, in which an open circuit voltage in a full charge state per a pair of the cathode and the anode is in the range from 4.25 V to 6.00 V, the cathode has a structure that a cathode active material layer including a cathode active material and a binder is provided on a cathode current collector, and the binder contains a polymer with intrinsic viscosity from 2.0 dl/g to 10 dl/g which contains vinylidene fluoride as an element.

According to an embodiment, the open circuit voltage in full charge is in the range from 4.25 V to 6.00 V. Therefore, a high energy density can be obtained. Further, since the cathode contains the polymer with intrinsic viscosity of 2.0 dl/g to 10 dl/g which contains vinylidene fluoride as an element, contact characteristics between the cathode active material layer and the cathode current collector can be maintained, and the charge and discharge efficiency can be improved.

Additional features and advantages are described herein, and will be apparent from, the following Detailed Description and the figures.

### BRIEF DESCRIPTION OF THE FIGURES

FIG. 1 is a cross section showing a structure of a secondary battery according to a first embodiment of the invention.

FIG. 2 is a cross section showing an enlarged part of a spirally wound electrode body in the secondary battery shown in FIG. 1.

FIG. 3 is an exploded perspective view showing a structure of a secondary battery according to a second embodiment of the invention.

FIG. 4 is a cross section taken along line I-I of a spirally wound electrode body shown in FIG. 3.

### DETAILED DESCRIPTION

Various embodiments of the invention will be hereinafter described in detail with reference to the drawings.

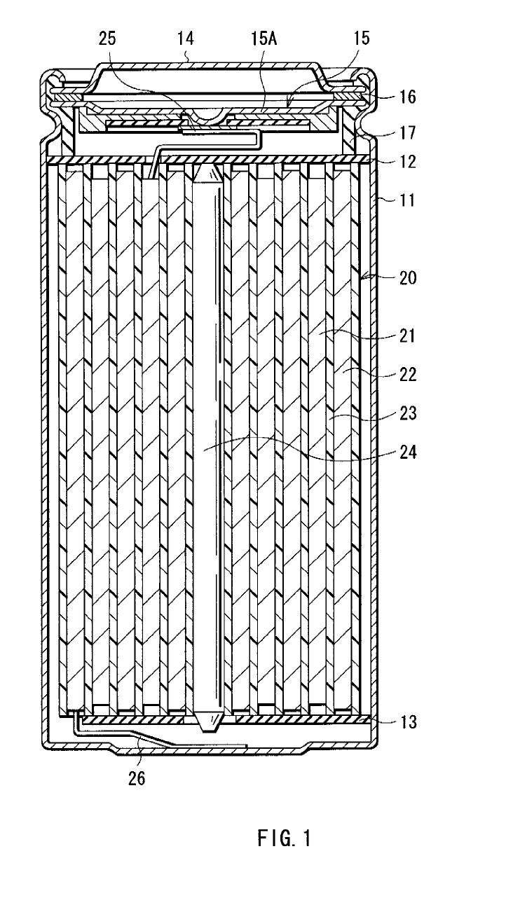

FIG. 1 shows a cross sectional structure of a secondary battery according to a first embodiment. In the secondary battery, lithium (Li) is used as an electrode reactant. The secondary battery is a so-called cylinder type battery, and has a spirally wound electrode body 20 in which a pair of a strip-shaped cathode 21 and a strip-shaped anode 22 is oppositely arranged with a separator 23 in between and wound inside a battery can 11 in the shape of an approximately hollow cylinder. The battery can 11 is made of, for example, iron (Fe) plated by nickel (Ni). One end of the battery can 11 is closed, and the other end thereof is opened. Inside the battery can 11, a pair of insulating plates 12 and 13 is respectively arranged perpendicular to the spirally wound periphery face, so that the spirally wound electrode body 20 is sandwiched between the insulating plates 12 and 13.

At the open end of the battery can 11, a battery cover 14, and a safety valve mechanism 15 and a PTC (Positive Temperature Coefficient) device 16 provided inside the battery cover 14 are attached by being caulked with a gasket 17. Inside of the battery can 11 is thereby hermetically sealed. The battery cover 14 is made of, for example, a material similar to that of the battery can 11. The safety valve mechanism 15 is electrically connected to the battery cover 14 through the PTC device 16. When the internal pressure of the battery becomes a certain level or more by internal short circuit, external heating or the like, a disk plate 15A flips to cut the electrical connection between the battery cover 14 and the spirally wound electrode body 20. When temperatures rise, the PTC device 16 limits a current by increasing the resistance value to prevent abnormal heat generation by a large current. The gasket 17 is made of, for example, an insulating material and its surface is coated with asphalt.

A center pin 24 is inserted in the center of the spirally wound electrode body 20. A cathode lead 25 made of aluminum (Al) or the like is connected to the cathode 21 of the spirally wound electrode body 20. An anode lead 26 made of nickel (Ni) or the like is connected to the anode 22. The cathode lead 25 is electrically connected to the battery cover 14 by being welded to the safety valve mechanism 15. The anode lead 26 is welded and electrically connected to the battery can 11.

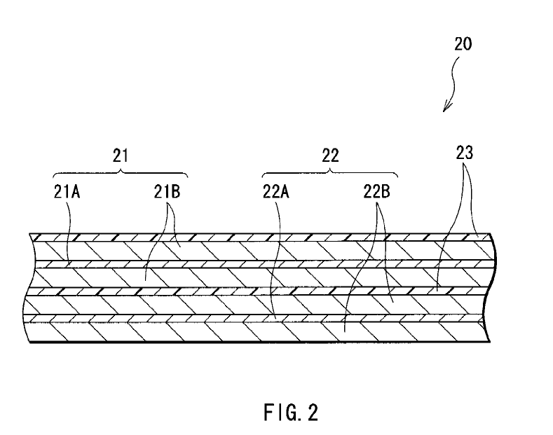

FIG. 2 shows an enlarged part of the spirally wound electrode body 20 shown in FIG. 1. The cathode 21 has a structure in which, for example, a cathode active material layer 21B is provided on the both faces of a cathode current collector 21A having a pair of faces opposing to each other. Though not shown, the cathode active material layer 21B may be provided on only one face of the cathode current collector 21A. The cathode current collector 21A is made of a metal foil such as an aluminum foil. The cathode active material layer 21B contains, for example, as a cathode active material, a cathode material capable of inserting and extracting lithium (Li).

As a cathode material capable of inserting and extracting lithium (Li), for example, a lithium-containing compound such as a lithium oxide, a lithium phosphorous oxide, a lithium sulfide, and an intercalation compound containing lithium (Li) is appropriate. Two or more thereof may be used by mixing. To improve the energy density, a lithium-containing compound which contains lithium (Li), transition metal elements, and oxygen (O) is preferable. Specially, a lithium-containing compound which contains at least one selected from the group consisting of cobalt (Co), nickel (Ni), manganese (Mn), and iron (Fe) as a transition metal element is more preferable.

As such a lithium-containing compound, for example, a first cathode material having the average composition shown in Chemical formula 1 and a second cathode material having the average composition shown in Chemical formula 2 can be cited. One thereof or a mixture thereof is preferably used. When the first cathode material is used, the filling amount in the cathode active material layer 21B can be increased and the energy density can be increased. However, when only the first cathode material is used, in the case of increasing the charging voltage, the cathode material, the electrolyte, or the separator is deteriorated and the charge and discharge efficiency is lowered. Meanwhile, when the mixture of the first cathode material and the second cathode material is used, such deterioration can be prevented.
LiₐCo_{1-b}M1_{b}O_{2-c} Chemical formula 1

In the formula, M1 represents at least one selected from the group consisting of manganese (Mn), nickel (Ni), magnesium (Mg), aluminum (Al), boron (B), titanium (Ti), vanadium (V), chromium (Cr), iron (Fe), copper (Cu), zinc (Zn), gallium (Ga), yttrium (Y), zirconium (Zr), niobium (Nb), molybdenum (Mo), tin (Sn), calcium (Ca), strontium (Sr), and tungsten (W). a, b, and care values in the range of0.9≦a≦1.1, 0≦b≦0.3, and −0.1≦c≦0.1. The composition of lithium varies according to charge and discharge states. A value of a represents the value in a full discharge state.
Li_{w}NiₓCo_{y}Mn_{z}M2_{1-x-y-z}O₂₋ᵥ Chemical formula 2

In the formula, M2 represents at least one selected from the group consisting of magnesium (Mg), aluminum (Al), boron (B), titanium (Ti), vanadium (V), chromium (Cr), iron (Fe), copper (Cu), zinc (Zn), gallium (Ga), yttrium (Y), zirconium (Zr), niobium (Nb), molybdenum (Mo), tin (Sn), calcium (Ca), strontium (Sr), and tungsten (W). v, w, x, y, and z are values in the range of −0.1≦v≦0.1, 0.9≦w≦1.1, 0≦x≦1, 0<y<0.7, 0<z<0.5, and 0≦1-x-y-z≦0.2. The composition of lithium varies according to charge and discharge states. A value of z represents the value in a full discharge state.

The weight ratio between the first cathode material and the second cathode material (first cathode material:second cathode material) is preferably in the range from 5:5 to 10:0, and more preferably in the range from 7:3 to 9:1. When the ratio of the first cathode material is small, the energy density is lowered. Meanwhile, when the ratio of the first cathode material is large, the charge and discharge efficiency is lowered.

The density of mixed powder of first cathode material powder and second cathode material powder is preferably 3.0 g/cm³ or more, and much more preferably 3.2 g/cm³ or more when pressurized by the pressure of 1 t/cm³. By appropriately adjusting the particle diameter distribution of the powder when forming the cathode 21 by compression molding, the capacity per unit volume can be increased. Specifically, when the particle diameter distribution of the powder is broad and the ratio of the powder with a small particle diameter is from 20 wt % to 50 wt %, adjustment can be made by narrowing the particle diameter distribution of the powder with a large particle diameter.

The specific surface area by BET (Brunauer Emmett Teller) method of the powder of the cathode material is preferably in the range from 0.05 m²/g to 10.0 m²/g, and more preferably in the range from 0.1 m²/g to 5.0 m²/g. In the foregoing range, reactivity between the cathode material and an electrolytic solution and the like can be lowered even if the battery voltage is increased. When mixed powder of a plurality of cathode materials is used, the specific surface area of the mixed powder is preferably in such a range.

As a lithium-containing compound, for example, a lithium complex oxide having a spinel structure shown in Chemical formula 3 or a lithium complex phosphate having an olivine structure shown in Chemical formula 4 or the like can be further cited. Specifically, Li_{d}Mₙ₂O₄ (d≈1) or LiₑFePO₄ (e≈1) and the like can be cited.
LiₚMn_{2-q}M4_{q}OᵣFₛ Chemical formula 3

In the formula, M4 represents at least one selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). p, q, r, and s are values in the range of 0.9≦p≦1.1, 0≦q≦0.6, 3.7≦r≦4.1, and 0≦s≦0.1. The composition of lithium varies according to charge and discharge states. A value of p represents the value in a full discharge state.
LiₜM5PO₄ Chemical formula 4

In the formula, M5 represents at least one selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr). t is a value in the range of 0.9≦t≦1.1. The composition of lithium varies according to charge and discharge states. A value of t represents the value in a full discharge state.

As a cathode material capable of inserting and extracting lithium (Li), in addition to the foregoing, an inorganic compound not containing lithium such as MnO₂, V₂O₅, V₆O₁₃, NiS, and MoS can be cited.

If necessary, the cathode active material layer 21B may contain an electrical conductor. As an electrical conductor, for example, a carbon material such as acetylene black, graphite and Ketjen black can be cited.

The cathode active material layer 21B further contains, as a binder, a polymer with intrinsic viscosity of 2.0 dl/g to 10 dl/g which contains vinylidene fluoride as an element. Thereby, the contact characteristics between the cathode active material layer 21B and the cathode current collector 21A are improved, increase of the electron transfer resistance due to lowering of the contact area between the cathode active material, the electrical conductor, and the cathode current collector is prevented, and the charge and discharge efficiency is improved. The intrinsic viscosity of the polymer is preferably in the range from 2.5 dl/g to 5.5 dl/g. Thereby, higher effects can be obtained.

As such a polymer, for example, polyvinylidene fluoride, a copolymer of polyvinylidene fluoride, a denatured polymer thereof and the like can be cited. As a copolymer, for example, vinylidene fluoride-hexafluoropropylene copolymer, vinylidene fluoride-tetrafluoroethylene copolymer, vinylidene fluoride-chlorotrifluoroethylene copolymer, vinylidene fluoride-hexafluoropropylene-tetrafluoroethylene copolymer, or a copolymer obtained by further copolymerizing other ethylene saturated monomer in addition to the foregoing can be cited. As a copolymerizable ethylene unsaturated monomer, for example, acrylic ester, methacrylic ester, vinyl acetate, acrylonitrile, acrylic acid, methacrylic acid, maleic anhydride, butadiene, styrene, N-vinyl pyrrolidone, N-vinyl pyridine, glycidyl methacrylate, hydroxyethyl methacrylate, methyl vinyl ether or the like can be cited. Specially, polyvinylidene fluoride is preferable, since durability, in particular, swelling resistance is superior. One of the foregoing polymers may be used singly, or a plurality thereof may be used by mixing. Further, a polymer with intrinsic viscosity out of the foregoing range or other binder may be mixed therein.

The content of the polymer in the cathode active material layer 21B is preferably in the range from 1 wt % to 7 wt %, and more preferably in the range from 2 wt % to 4 wt %. When the content of the polymer is small, the binding characteristics are not sufficient and it becomes difficult to bind the cathode active material or the like to the cathode current collector 21A. Meanwhile, when the content of the polymer is large, the cathode active material is coated with the polymer with low electron conductivity and low ion conductivity, and charge and discharge efficiency is lowered.

The anode 22 has a structure in which an anode active material layer 22B is provided on the both faces of an anode current collector 22A having a pair of faces opposing to each other. Though not shown, the anode active material layer 22B may be provided only on one face of the anode current collector 22A. The anode current collector 22A is made of, for example, a metal foil such as a copper foil.

The anode active material layer 22B contains, as an anode active material, one or more anode materials capable of inserting and extracting lithium (Li).

In the secondary battery, the electrochemical equivalent of the anode material capable of inserting and extracting lithium (Li) is larger than the electrochemical equivalent of the cathode 21. Therefore, lithium metal is not precipitated on the anode 22 during charge.

Further, in the secondary battery, the open circuit voltage in full charge (that is, battery voltage) is designed to fall within the range from 4.25 V to 6.00 V. Therefore, in the secondary battery, the lithium extraction amount per unit weight is larger than that in the battery in which the open circuit voltage in full charge is 4.20 V even though the same cathode active material is used. Accordingly, the amounts of the cathode active material and the anode active material are adjusted. Thereby, a higher energy density can be obtained. In particular, when the open circuit voltage in full charge is in the range from 4.25 V to 4.50 V, effects of using the polymer with the foregoing intrinsic viscosity which contains vinylidene fluoride as an element become high.

As an anode material capable of inserting and extracting lithium (Li), for example, a carbon material such as non-graphitizable carbon, graphitizable carbon, graphite, pyrolytic carbons, coke, glassy carbons, an organic high molecular weight compound fired body, carbon fiber, and activated carbon can be cited. Of the foregoing, coke includes pitch coke, needle coke, petroleum coke and the like. The organic high molecular weight compound fired body is obtained by firing and carbonizing a high molecular weight material such as a phenol resin and a furan resin at appropriate temperatures, and some thereof are categorized as non-graphitizable carbon or graphitizable carbon. As a high molecular weight material, polyacetylene, polypyrrole or the like can be cited. These carbon materials are preferable, since the crystal structure change generated in charge and discharge is very small, a high charge and discharge capacity can be obtained, and favorable cycle characteristics can be obtained. In particular, graphite is preferable, since the electrochemical equivalent is large, and a high energy density can be obtained. Further, non-graphitizable carbon is preferable since superior characteristics can be obtained. Furthermore, a material with a low charge and discharge electric potential, specifically a material with the charge and discharge electric potential close to of lithium metal is preferable, since a high energy density of the battery can be thereby easily realized.

When a carbon material is used as an anode material capable of inserting and extracting lithium (Li), the area density ratio of the cathode active material layer 21B to the anode active material layer 22B (area density of the cathode active material layer 21B/area density of the anode active material layer 22B) is preferably in the range from 1.70 to 2.10. When the area density is large, metal lithium is precipitated on the surface of the anode 22, and thus the charge and discharge efficiency, the safety and the like are lowered. Meanwhile, when the area density ratio is small, the anode material not being involved in reaction with lithium (Li) as an electrode reactant is increased, and the energy density is lowered.

As an anode material capable of inserting and extracting lithium (Li), a material which is capable of inserting and extracting lithium (Li) and contains at least one of metal elements and metalloid elements as an element can be also cited. When such a material is used, a high energy density can be obtained. In particular, such a material is more preferably used together with a carbon material, since a high energy density can be obtained, and superior cycle characteristics can be obtained. Such an anode material may be a simple substance, an alloy, or a compound of a metal element or a metalloid element, or may have one or more phases thereof at least in part. In the invention, alloys include an alloy containing one or more metal elements and one or more metalloid elements, in addition to an alloy including two or more metal elements. Further, an alloy may contain nonmetallic elements. The texture thereof includes a solid solution, a eutectic crystal (eutectic mixture), an intermetallic compound, and a texture in which two or more thereof coexist.

As a metal element or a metalloid element composing the anode material, for example, magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium, yttrium (Y), palladium (Pd), or platinum (Pt) can be cited. They may be crystalline or amorphous.

As the anode material, a material containing a metal element or a metalloid element of Group 4B in the short period periodic table as an element is preferable. A material containing at least one of silicon (Si) and tin (Sn) as an element is particularly preferable. Silicon (Si) and tin (Sn) have a high ability to insert and extract lithium (Li), and can obtain a high energy density.

As an alloy of tin (Sn), for example, an alloy containing at least one selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a second element other than tin (Sn) can be cited. As an alloy of silicon (Si), for example, an alloy containing at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a second element other than silicon (Si) can be cited.

As a compound of tin (Sn) or a compound of silicon (Si), for example, a compound containing oxygen (O) or carbon (C) can be cited. In addition to tin (Sn) or silicon (Si), the compound may contain the foregoing second element.

As an anode material capable of inserting and extracting lithium (Li), other metal compound or a high molecular weight material can be further cited. As other metal compound, an oxide such as MnO₂, V₂O₅, and V₆O₁₃; a sulfide such as NiS and MoS; or a lithium nitride such as LiN₃ can be cited. As a high molecular weight material, polyacetylene, polyaniline, polypyrrole or the like can be cited.

If necessary, the anode active material layer 22B may contain an electrical conductor and a binder. As an electrical conductor, for example, graphites such as artificial graphite and expanded graphite, carbon blacks such as acetylene black, Ketjen black, channel black, and furnace black, conducive fibers such as carbon fiber and metal fiber, metal powder such as copper powder and nickel powder, and organic conductive materials such as polyphenylene derivative can be cited. Acetylene black, Ketjen black, or carbon fiber is preferable. The addition amount of the electrical conductor is preferably in the range from 0.1 parts by weight to 30 parts by weight to 100 parts by weight of the anode material, and more preferably in the range from 0.5 parts by weight to 10 parts by weight to 100 parts by weight of the anode material. One electrical conductor may be used singly, or a plurality thereof may be used by mixing. As a binder, for example, polytetrafluoroethylene or polyvinylidene fluoride can be cited. One binder may be used singly, or a plurality thereof may be used by mixing.

The separator 23 has, for example, a base material layer and a surface layer provided on at least part of the face of the base material layer which is opposed to the cathode 21, more preferably on the whole face of the base material layer which is opposed to the cathode 21, and much more preferably on the both faces of the base material layer. The base material layer is made of, for example, a porous film made of a synthetic resin such as polypropylene and polyethylene. The base material layer may have a structure in which two or more porous films such as the foregoing porous films are layered. Specially, the polyolefin porous film is preferable since the polyolefin porous film has a superior short circuit prevention effect and provides improved safety of the battery by shut down effect. In particular, as a material composing the base material layer, polyethylene is preferable, since polyethylene obtains shutdown effects in the range from 100 deg C. to 160 deg C. and has superior electrochemical stability. Further, polypropylene is also preferable. In addition, as long as a resin has chemical stability, such a resin may be used by being copolymerized with polyethylene or polypropylene, or by being blended with polyethylene or polypropylene.

The surface layer contains at least one of polyvinylidene fluoride and polypropylene. Thereby, chemical stability is improved, and lowering of the charge and discharge efficiency due to occurrence of micro short circuit is prevented. When the surface layer is formed from polypropylene, the base material layer may be formed from polypropylene and structured as a monolayer.

The thickness of the surface layer on the side opposed to the cathode 21 is preferably in the range from 0.1 μm to 10 μm. When the thickness is small, the effect of prevented occurrence of micro short circuit is small. Meanwhile, when the thickness is large, the ion conductivity is lowered, and the volume capacity is lowered.

The pore size of the separator 23 is preferably in the range in which an eluting material or the like from the cathode 21 or the anode 22 is not permeated the separator 23. Specifically, the pore size of the separator 23 is preferably in the range from 0.01 μm to 1 μm. The thickness of the separator 23 is preferably in the range from 10 μm to 300 μm, and more preferably in the range from 15 μm to 30 μm. When the separator is thin, short circuit may occur. Meanwhile, when the separator is thick, the filling amount of the cathode material is decreased. The porosity of the separator 23 is determined by electron permeability and ion permeability, the material, or the thickness. In general, the porosity of the separator 23 is in the range from 30 volume % to 80 volume %, and more preferably in the range from 35 volume % to 50 volume %. When the porosity is low, ion conductivity is lowered. Meanwhile, when the porosity is high, short circuit may occur.

An electrolytic solution as a liquid electrolyte is impregnated in the separator 23. The electrolytic solution contains, for example, a solvent and an electrolyte salt dissolved in the solvent.

As a solvent, a cyclic ester carbonate such as ethylene carbonate and propylene carbonate can be used. One of ethylene carbonate and propylene carbonate is preferably used. In particular, a mixture of the both is more preferably used. Thereby, the cycle characteristics can be improved.

As a solvent, further, a chain ester carbonate such as diethyl carbonate, dimethyl carbonate, ethyl methyl carbonate, and methyl propyl carbonate is preferably mixed with the foregoing cyclic ester carbonate. Thereby, high ion conductivity can be obtained.

As a solvent, furthermore, 2,4-difluoro anisole or vinylene carbonate is preferably contained. 2,4-difluoro anisole can improve the discharge capacity, and vinylene carbonate can improve the cycle characteristics. Therefore, 2,4-difluoro anisole and vinylene carbonate are preferably mixed in the solvent, since the discharge capacity and the cycle characteristics can be thereby improved.

In addition, as other solvent, butylene carbonate, y-butyrolactone, y-valerolactone, 1,2-dimethoxyethane, tetrahydrofuran, 2-methyltetrahydrofuran, 1,3-dioxolan, 4-methyl-1,3-dioxolan, methyl acetate, methyl propionate, acetonitrile, glutaronitrile, adiponitrile, methoxy acetonitrile, 3-methoxy propylonitrile, N,N-dimethylformamide, N-methyl pyrrolidinone, N-methyl oxazolidinone, N,N′-dimethyl imidazolidinone, nitromethane, nitroethane, sulfolane, dimethyl sulfoxide, or trimethyl phosphate can be cited.

In some cases, a compound obtained by substituting at least part of hydrogen of the foregoing nonaqueous solvent with fluorine is preferable, since such a compound may improve reversibility of electrode reaction depending on the electrode type to be combined.

As an electrolyte salt, for example, a lithium salt can be cited. One lithium salt may be used singly, or two or more lithium salts may be used by mixing. As a lithium salt, LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, LiBr or the like can be cited. Specially, LiPF₆ is preferable since high ion conductivity can be obtained, and the cycle characteristics can be improved.

The secondary battery can be manufactured, for example, as follows.

First, for example, a cathode active material, an electrical conductor, and a polymer with the foregoing intrinsic viscosity which contains vinylidene fluoride as an element are mixed to prepare a cathode mixture, which is dispersed in a solvent such as N-methyl-2-pyrrolidone to obtain paste cathode mixture slurry. Next, the cathode current collector 21A is coated with the cathode mixture slurry, the solvent is dried, and the resultant is compression-molded by a rolling press machine or the like to form the cathode active material layer 21B and thereby forming the cathode 21.

Further, for example, an anode active material and a binder are mixed to prepare an anode mixture, which is dispersed in a solvent such as N-methyl-2-pyrrolidone to obtain paste anode mixture slurry. Next, the anode current collector 22A is coated with the anode mixture slurry, the solvent is dried, and the resultant is compression-molded by a rolling press machine or the like to form the anode active material layer 22B and thereby forming the anode 22.

Subsequently, the cathode lead 25 is attached to the cathode current collector 21A by welding or the like, and the anode lead 26 is attached to the anode current collector 22A by welding or the like. After that, the cathode 21 and the anode 22 are wound with the separator 23 in between. The end of the cathode lead 25 is welded to the safety valve mechanism 15, and the end of the anode lead 26 is welded to the battery can 11. The wound cathode 21 and the wound anode 22 are sandwiched between the pair of insulating plates 12 and 13, and contained inside the battery can 11. After the cathode 21 and the anode 22 are contained inside the battery can 11, an electrolytic solution is injected inside the battery can 11 and impregnated in the separator 23. After that, at the open end of the battery can 11, the battery cover 14, the safety valve mechanism 15, and the PTC device 16 are fixed by being caulked with the gasket 17. The secondary battery shown in FIG. 1 is thereby completed.

In the secondary battery, when charged, lithium ions are extracted from the cathode active material layer 21B and inserted in the anode material capable of inserting and extracting lithium (Li) contained in the anode active material layer 22B through the electrolytic solution. Next, when discharged, the lithium ions inserted in the anode material capable of inserting and extracting lithium (Li) in the anode active material layer 22B are extracted, and inserted in the cathode active material layer 21B through the electrolytic solution. Here, the polymer with the foregoing intrinsic viscosity which contains vinylidene fluoride as an element is contained in the cathode 21. Therefore, even when the open circuit voltage in full charge is increased, the contact characteristics between the cathode active material layer 21B and the cathode current collector 21A are maintained, and the charge and discharge efficiency is improved.

As above, according to the secondary battery of this embodiment, since the open circuit voltage in full charge is in the range from 4.25 V to 6.00 V, a high energy density can be obtained. Further, in this embodiment, the polymer with the intrinsic viscosity of 2.0 dl/g to 10 dl/g which contains vinylidene fluoride as an element is contained in the cathode 21. Therefore, the contact characteristics between the cathode active material layer 21B and the cathode current collector 21A can be maintained, and the charge and discharge efficiency can be improved.

In particular, when the intrinsic viscosity of the polymer is in the range from 2.5 dl/g to 5.5 dl/g, higher effects can be obtained.

Further, when at least one of the first cathode material and the second cathode material is used or when a mixture thereof is used, the energy density can be more improved and the charge and discharge efficiency can be more improved. In particular, when the weight ratio between the first cathode material and the second cathode material (first cathode material:second cathode material) is in the range from 5:5 to 9:1, higher effects can be obtained.

Furthermore, in the case that a carbon material is contained in the anode active material layer 22B, when the area density ratio of the cathode active material layer 21B to the anode active material layer 22B (area density of the cathode active material layer 21B/area density of the anode active material layer 22B) is in the range from 1.70 to 2.10, the energy density can be more improved, and the charge and discharge efficiency can be more improved.

In addition, when at least part of the separator 23 on the cathode 21 side is made of at least one of polyvinylidene fluoride and polypropylene, the charge and discharge efficiency can be further improved.

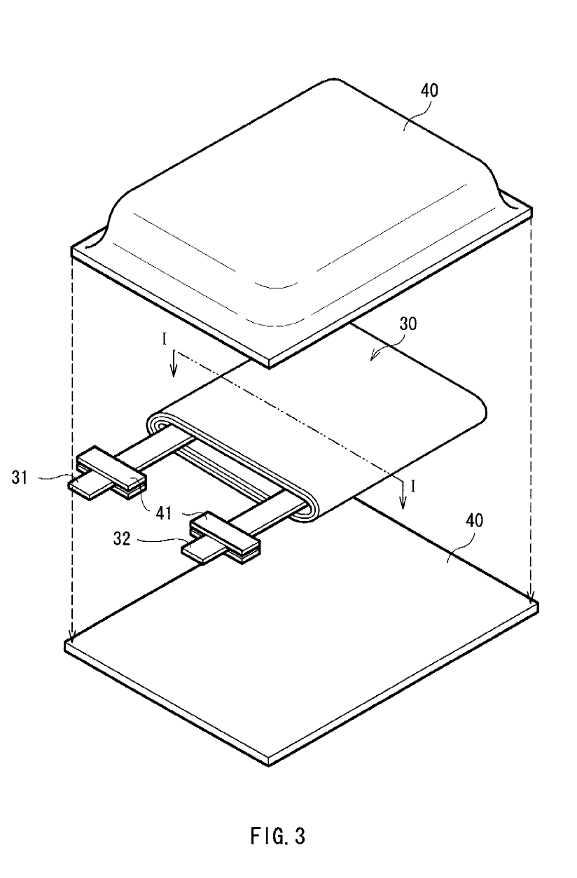

FIG. 3 shows a structure of a secondary battery according to a second embodiment of the invention. In the secondary battery, a spirally wound electrode body 30 on which a cathode lead 31 and an anode lead 32 are attached is contained inside a film package member 40. Therefore, the size, the weight, and the thickness thereof can be decreased.

The cathode lead 31 and the anode lead 32 are respectively directed from inside to outside of the package member 40 in the same direction, for example. The cathode lead 31 and the anode lead 32 are respectively made of, for example, a metal material such as aluminum (Al), copper (Cu), nickel (Ni), and stainless, and are in the shape of a thin plate or mesh.

The package member 40 is made of a rectangular aluminum laminated film in which, for example, a nylon film, an aluminum foil, and a polyethylene film are bonded together in this order. The package member 40 is, for example, arranged so that the polyethylene film side and the spirally wound electrode body 30 are opposed, and the respective outer edges are contacted to each other by fusion bonding or an adhesive. Adhesive films 41 to protect from outside air intrusion are inserted between the package member 40 and the cathode lead 31, the anode lead 32. The adhesive film 41 is made of a material having contact characteristics to the cathode lead 31 and the anode lead 32, for example, is made of a polyolefin resin such as polyethylene, polypropylene, modified polyethylene, and modified polypropylene.

The exterior member 40 may be made of a laminated film having other structure, a high molecular weight film such as polypropylene, or a metal film, instead of the foregoing aluminum laminated film.

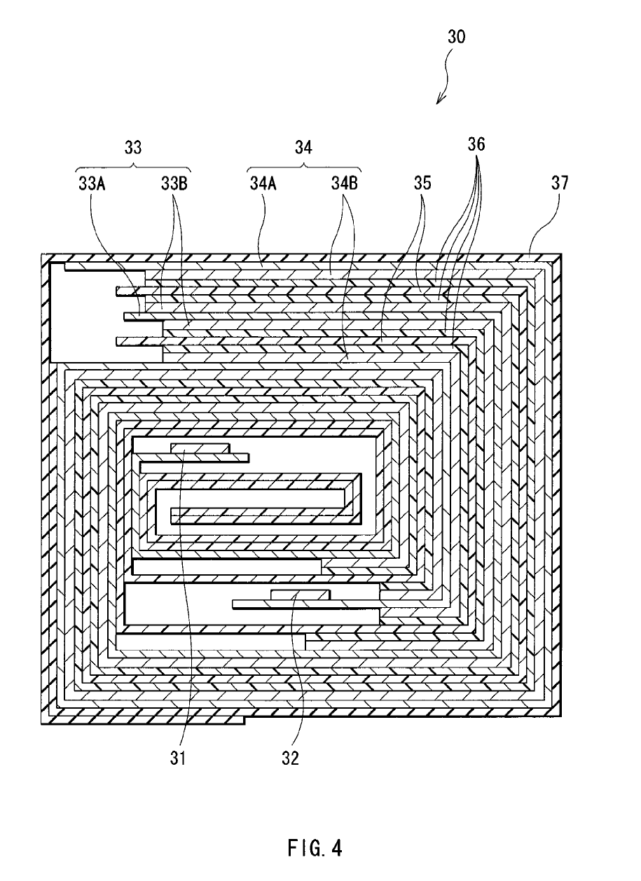

FIG. 4 shows a cross sectional structure taken along line I-I of the spirally wound electrode body 30 shown in FIG. 3. In the spirally wound electrode body 30, a cathode 33 and an anode 34 are oppositely arranged with a separator 35 and an electrolyte layer 36 in between and wound. The outermost periphery thereof is protected by a protective tape 37.

The cathode 33 has a structure in which a cathode active material layer 33B is provided on one face or the both faces of a cathode current collector 33A. The anode 34 has a structure in which an anode active material layer 34B is provided on one face or the both faces of an anode current collector 34A. Arrangement is made so that the anode active material layer 34B side is opposed to the cathode active material layer 33B. The structures of the cathode current collector 33A, the cathode active material layer 33B, the anode current collector 34A, the anode active material layer 34B, and the separator 35 are similar to of the cathode current collector 21A, the cathode active material layer 21B, the anode current collector 22A, the anode active material layer 22B, and the separator 23 respectively described in the first embodiment.

The electrolyte layer 36 is so-called gelatinous, containing an electrolytic solution and a high molecular weight compound to become a holding body which holds the electrolytic solution. The gelatinous electrolyte layer 36 is preferable, since high ion conductivity can be obtained and liquid leakage of the battery can be prevented. The structure of the electrolytic solution (that is, a solvent, an electrolyte salt and the like) is similar to of the secondary batteries according to the first embodiment. As a high molecular weight compound, for example, polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazen, polysiloxane, polyvinyl acetate, polyvinyl alcohol, polymethacrylic acid methyl, polyacrylic acid, polymethacrylic acid, styrene-butadiene rubber, nitrile-butadiene rubber, polystyrene, or polycarbonate can be cited. In particular, in view of electrochemical stability, polyacrylonitrile, polyvinylidene fluoride, polyhexafluoropropylene, or polyethylene oxide is preferable.

The secondary battery can be manufactured, for example, as follows.

First, the cathode 33 and the anode 34 are respectively coated with a precursor solution containing a solvent, an electrolyte salt, a high molecular weight compound, and a mixed solvent. The mixed solvent is volatilized to form the electrolyte layer 36. After that, the cathode lead 31 is welded to the end of the cathode current collector 33A, and the anode lead 32 is welded to the end of the anode current collector 34A. Next, the cathode 33 and the anode 34 formed with the electrolyte layer 36 are layered with the separator 35 in between to obtain a lamination. After that, the lamination is wound in the longitudinal direction, the protective tape 37 is adhered to the outermost periphery thereof to form the spirally wound electrode body 30. Lastly, for example, the spirally wound electrode body 30 is sandwiched between the package members 40, and outer edges of the exterior members 40 are contacted to each other by thermal fusion bonding or the like to enclose the spirally wound electrode body 30. Then, the adhesive films 41 are inserted between the cathode lead 31, the anode lead 32 and the exterior member 40. Thereby, the secondary battery shown in FIG. 3 and FIG. 4 is completed.

Otherwise, the secondary battery may be fabricated as follows. First, the cathode 33 and the anode 34 are formed as described above, and the cathode lead 31 and the anode lead 32 are attached on the cathode 33 and the anode 34. After that, the cathode 33 and the anode 34 are layered with the separator 35 in between and wound. The protective tape 37 is adhered to the outermost periphery thereof, and a spirally wound body as a precursor of the spirally wound electrode body 30 is formed. Next, the spirally wound body is sandwiched between the exterior members 40, the peripheral edges except for one side are thermally fusion-bonded to obtain a pouched state, and the spirally wound body is contained inside the exterior member 40. Subsequently, an electrolytic composition containing a solvent, an electrolyte salt, a monomer as a raw material for the high molecular weight compound, and if necessary other material such as a polymerization initiator or a polymerization inhibitor is prepared, which is injected inside the package member 40.

After the electrolytic composition is injected, the opening of the package member 40 is thermally fusion-bonded and hermetically sealed in the vacuum atmosphere. Next, the resultant is heated to polymerize the monomer to obtain a high molecular weight compound. Thereby, the gelatinous electrolyte layer 36 is formed, and the secondary battery shown in FIG. 3 and FIG. 4 is assembled.

The secondary battery provides an action and effects similar to those of the secondary battery according to the first embodiment.

### EXAMPLES 1-1 TO 1-4, 2-1 TO 2-4, 3-1 TO 3-4, AND 4-1 TO 4-4

First, lithium hydroxide (LiOH) and a coprecipitated hydroxide expressed as Co_{0.98}Al_{0.01}Mg_{0.01}(OH)₂ were mixed so that the mol ratio between lithium and the total of other metal elements became Li:(Co+Al+Mg)=1:1. A mixture thereof was provided with heat treatment for 12 hours at 800 deg C. in the air. Thereby, the first cathode material with the average composition expressed as LiCo_{0.98}Al_{0.01}Mg_{0.01}O₂ was formed. Next, the obtained first cathode material was pulverized, and a cathode material with the specific surface area by BET of 0.44 m²/g and the average particle diameter of 6.2 μm and a cathode material with the specific surface area by BET of 0.20 m²/g and the average particle diameter of 16.7 μm were therefrom formed. These cathode materials were mixed at a weight ratio of 15:85.

Further, lithium hydroxide and a coprecipitated hydroxide expressed as Ni_{0.5}Co_{0.2}Mn_{0.3}(OH)₂ were mixed so that the mol ratio between lithium and the total of other metal elements became Li:(Ni+Co+Mn)=1:1. A mixture thereof was provided with heat treatment for 20 hours at 1000 deg C. in the air. Thereby, the second cathode material with the average composition expressed as LiNi_{0.5}Co_{0.2}Mn_{0.3}O₂ was formed. Next, the obtained second cathode material was pulverized. For the pulverized second cathode material, the specific surface area by BET was 0.38 m²/g and the average particle diameter was 11.5 μm.

For the formed first cathode material and the formed second cathode material, X-ray diffraction measurement by CuKα was performed. It was confirmed that both the first cathode material and the second cathode material had a bedded salt structure of R-3m rhombohedron.

Subsequently, by using the formed first cathode material and the formed second cathode material, the secondary battery shown in FIGS. 1 and 2 was fabricated. First, the first cathode material, the second cathode material, Ketjen black as an electrical conductor, polyvinylidene fluoride (PVDF) as a polymer which is a binder were mixed at a weight ratio of first cathode material:second cathode material:Ketjen black:polyvinylidene fluoride=76.4:19.1:1.5:3.0 to prepare a cathode mixture. Polyvinylidene fluoride with the intrinsic viscosity of 2.0 dl/g, 3.1 dl/g, 5.2 dl/g, or 9.8 dl/g was used. The intrinsic viscosity was measured based on Mathematical formula 1 by using Ubbelohde's viscometer for a solution obtained by dissolving 80 mg of polyvinylidene fluoride powder in 20 ml of N,N-dimethyl formamide. Measurement was made in a constant temperature bath at 30 deg C.
ηi=(1/C)·ln(η/η0) Mathematical formula 1

In the formula, ηi represents an intrinsic viscosity, η represents viscosity of the solution, η0 represents viscosity of N,N-dimethyl formamide only, and C represents a density which is 0.4 g/dl.

Subsequently, the cathode mixture was dispersed in N-methyl-2-pyrrolidone as a solvent to obtain cathode mixture slurry. The both faces of the cathode current collector 21A made of a strip-shaped aluminum foil being 20 μm thick were uniformly coated with the cathode mixture slurry, which was dried and compression-molded by a rolling press machine to form the cathode active material layer 21B and thereby forming the cathode 21. Subsequently, the cathode lead 25 made of nickel was attached to the cathode current collector 21A.

Further, granular artificial graphite powder with the specific surface area by BET of 0.58 m²/g as an anode material, vapor phase epitaxial carbon fiber as an electrical conductor, and polyvinylidene fluoride as a binder were mixed to prepare an anode mixture. Next, the anode mixture was dispersed in N-methyl-2-pyrrolidone as a solvent to obtain anode mixture slurry. The both faces of the anode current collector 22A made of a strip-shaped copper foil being 12 μm thick were uniformly coated with the anode mixture slurry, which was compression-molded by a rolling press machine to form the anode active material layer 22B and thereby forming the anode 22. Subsequently, the anode lead 26 made of nickel was attached to the anode current collector 22A. The amounts of the cathode material and the anode material were adjusted according to the open circuit voltage in full charge, and design was made so that the capacity of the anode 22 was expressed by the capacity component by insertion and extraction of lithium. The open circuit voltage in full charge was 4.25 V in Examples 1-1 to 1-4, 4.30 V in Examples 2-1 to 2-4, 4.40 V in Examples 3-1 to 3-4, and 4.50 V in Examples 4-1 to 4-4. The area density ratio of the cathode active material layer 21B to the anode active material layer 22B was as shown in Tables 1 and 2.

After the cathode 21 and the anode 22 were respectively formed, the separator 23 made of a microporous film was prepared. Then, the anode 22, the separator 23, the cathode 21, and the separator 23 were layered in this order, and the resultant lamination was spirally wound many times. Thereby, the jellyroll type spirally wound electrode body 20 was formed. For the separator 23, the separator with three-layer structure in which a polypropylene layer was provided on the both faces of a polyethylene layer was used. After the spirally wound electrode body 20 was formed, the spirally wound electrode body 20 was sandwiched between the pair of insulating plates 12 and 13. The anode lead 26 was welded to the battery can 11, the cathode lead 25 was welded to the safety valve mechanism 15, and the spirally wound electrode body 20 was contained inside the battery can 11. After that, an electrolytic solution was injected inside the battery can 11. The battery cover 14 and the battery can 11 were caulked with the gasket 17 to obtain a cylinder type secondary battery. For the electrolytic solution, an electrolytic solution obtained by dissolving LiPF₆ as an electrolyte salt in a mixed solvent of 15 wt % of ethylene carbonate, 12 wt % of propylene carbonate, 5 wt % of ethyl methyl carbonate, 67 wt % of dimethyl carbonate, and 1 wt % of vinylene carbonate so that LiPF₆ became 1.5 mol/kg was used.

As Comparative examples 1-1, 1-2, 2-1, 2-2, 3-1, 3-2, 4-1, and 4-2 relative to these examples, secondary batteries were fabricated in the same manner as in these examples, except that polyvinylidene fluoride with intrinsic viscosity of 1.3 dl/g or 1.5 dl/g was used in forming the cathode active material layer. The open circuit voltage in full charge was 4.25 V in Comparative examples 1-1 and 1-2, 4.35 V in Comparative examples 2-1 and 2-2, 4.40 V in Comparative examples 3-1 and 3-2, and 4.50 V in Comparative examples 4-1 and 4-2.

Further, as Comparative examples 5-1 to 5-6, secondary batteries were fabricated in the same manner as in these examples, except that the intrinsic viscosity of polyvinylidene fluoride used in forming the cathode active material layer 21B was changed in the range from 1.3 dl/g to 9.8 dl/g and the open circuit voltage in full charge was 4.20 V. The area density ratio of the cathode active material layer 21B to the anode active material layer 22B in Comparative examples 5-1 to 5-5 was as shown in Table 2.

For the obtained secondary batteries of each example and each comparative example, charge and discharge were performed at 25 deg C., and the discharge capacity at the 5th cycle and the discharge capacity retention ratio at the 200th cycle were examined. Charge was performed in such a way that after constant-current charge was performed at 2400 mA until the upper limit voltage, charge was performed until the charging current was attenuated to 10 mA at the upper limit voltage. Discharge was performed at a constant current of 2400 mA until the terminal voltage reached 3.0 V. The upper limit voltage was 4.25 V in Examples 1-1 to 1-4 and Comparative examples 1-1 and 1-2, 4.30 V in Examples 2-1 to 2-4 and Comparative examples 2-1 and 2-2, 4.40 V in Examples 3-1 to 3-4 and Comparative examples 3-1 and 3-2, 4.50 V in Examples 4-1 to 4-4 and Comparative examples 4-1 and 4-2, and 4.20 V in Comparative examples 5-1 to 5-6. The capacity retention ratio at the 200th cycle was obtained as the ratio of the discharge capacity at the 200th cycle to the discharge capacity at the third cycle, that is, (discharge capacity at the 200th cycle/discharge capacity at the third cycle)×100 (%). The discharge capacity means a value per 1 g of the cathode active material layer 21B. The discharge capacity was obtained by the formula, (discharge capacity of the battery (mAh)/amount of the cathode active material layer (g)).

Further, the secondary batteries of each example and each comparative example were repeatedly charged and discharged 200 cycles, and then disassembled. After that, separation states of the cathode active material layer 21B were visually observed. The secondary battery in which separation of the cathode active material layer 21B was about under 50% was evaluated as ∘, the secondary battery in which separation of the cathode active material layer 21B was from 50% to under 80% was evaluated as Δ, and the secondary battery in which separation of the cathode active material layer 21B was 80% or more was evaluated as ×. Results obtained are shown in Tables 1 and 2.

TABLE 1

| | | | | | Discharge | |
|---|---|---|---|---|---|---|
| | | | | Discharge | capacity | |
| | Upper limit | Intrinsic | | capacity at | retention ratio | Cathode after |
| | voltage of | viscosity of | Area density | the 5th cycle | at the 200th | charge and |
| | charge (V) | PVDF (dl/g) | ratio | (mAh/g) | cycle (%) | discharge |
| Comparative | 4.25 | 1.3 | 2.10 | 165 | 85 | Δ |
| example 1-1 | | | | | | |
| Comparative | 4.25 | 1.5 | 2.10 | 163 | 87 | Δ |
| example 1-2 | | | | | | |
| Example 1-1 | 4.25 | 2.0 | 2.10 | 165 | 90 | ◯ |
| Example 1-2 | 4.25 | 3.1 | 2.10 | 167 | 91 | ◯ |
| Example 1-3 | 4.25 | 5.2 | 2.10 | 168 | 90 | ◯ |
| Example 1-4 | 4.25 | 9.8 | 2.10 | 163 | 90 | ◯ |
| Comparative | 4.35 | 1.3 | 1.94 | 170 | 80 | X |
| example 2-1 | | | | | | |
| Comparative | 4.35 | 1.5 | 1.94 | 171 | 83 | Δ |
| example 2-2 | | | | | | |
| Example 2-1 | 4.35 | 2.0 | 1.94 | 171 | 90 | ◯ |
| Example 2-2 | 4.35 | 3.1 | 1.94 | 172 | 89 | ◯ |
| Example 2-3 | 4.35 | 5.2 | 1.94 | 171 | 90 | ◯ |
| Example 2-4 | 4.35 | 9.8 | 1.94 | 170 | 88 | ◯ |
| Comparative | 4.40 | 1.3 | 1.86 | 177 | 76 | X |
| example 3-1 | | | | | | |
| Comparative | 4.40 | 1.5 | 1.86 | 178 | 80 | X |
| example 3-2 | | | | | | |
| Example 3-1 | 4.40 | 2.0 | 1.86 | 177 | 88 | ◯ |
| Example 3-2 | 4.40 | 3.1 | 1.86 | 176 | 87 | ◯ |
| Example 3-3 | 4.40 | 5.2 | 1.86 | 178 | 88 | ◯ |
| Example 3-4 | 4.40 | 9.8 | 1.86 | 177 | 88 | ◯ |

PVDF: polyvinylidene fluoride

TABLE 2

| | | | | | Discharge | |
|---|---|---|---|---|---|---|
| | | | | Discharge | capacity | |
| | Upper limit | Intrinsic | | capacity at | retention ratio | Cathode after |
| | voltage of | viscosity of | Area density | the 5th cycle | at the 200th | charge and |
| | charge (V) | PVDF (dl/g) | ratio | (mAh/g) | cycle (%) | discharge |
| Comparative | 4.50 | 1.3 | 1.70 | 187 | 65 | X |
| example 4-1 | | | | | | |
| Comparative | 4.50 | 1.5 | 1.70 | 188 | 76 | X |
| example 4-2 | | | | | | |
| Example 4-1 | 4.50 | 2.0 | 1.70 | 187 | 83 | ◯ |
| Example 4-2 | 4.50 | 3.1 | 1.70 | 187 | 82 | ◯ |
| Example 4-3 | 4.50 | 5.2 | 1.70 | 188 | 83 | ◯ |
| Example 4-4 | 4.50 | 9.8 | 1.70 | 189 | 84 | ◯ |
| Comparative | 4.20 | 1.3 | 2.20 | 156 | 90 | ◯ |
| example 5-1 | | | | | | |
| Comparative | 4.20 | 1.5 | 2.20 | 155 | 91 | ◯ |
| example 5-2 | | | | | | |
| Comparative | 4.20 | 2.0 | 2.20 | 157 | 90 | ◯ |
| example 5-3 | | | | | | |
| Comparative | 4.20 | 3.1 | 2.20 | 156 | 91 | ◯ |
| example 5-4 | | | | | | |
| Comparative | 4.20 | 5.2 | 2.20 | 155 | 90 | ◯ |
| example 5-5 | | | | | | |
| Comparative | 4.20 | 9.8 | 2.20 | 157 | 90 | ◯ |
| example 5-6 | | | | | | |

PVDF: polyvinylidene fluoride

As shown in Tables 1 and 2, when the open circuit voltage in full charge was higher then 4.20 V, separation of the cathode active material layer 21B was smaller and the discharge capacity retention ratio could be improved in the examples in which the intrinsic viscosity of polyvinylidene fluoride used for the cathode active material layer 21B was 2.0 dl/g or more than in the comparative examples in which the intrinsic viscosity was small. Meanwhile, in Comparative examples 5-1 to 5-6, in which the open circuit voltage in full charge was 4.20 V, characteristics difference due to the intrinsic viscosity of polyvinylidene fluoride used for the cathode active material layer 21B was not shown.

That is, it was found that when the polymer with intrinsic viscosity of 2.0 dl/g to 10 dl/g which contains vinylidene fluoride as an element was used for the cathode active material layer 21B, separation of the cathode active material layer 21B could be prevented and superior cycle characteristics could be obtained even if the open circuit voltage in full charge was 4.25 V or more.

### EXAMPLES 6-1 TO 6-3

In Examples 6-1 and 6-2, secondary batteries were fabricated in the same manner as in Example 3-2, except that the ratio of polyvinylidene fluoride in the cathode mixture was changed to 2.0 wt % or 4.0 wt %, and accordingly the ratio of the cathode active material in the cathode mixture was changed. The ratio between the first cathode material and the second cathode material in the cathode active material was first cathode material:second cathode material=8:2 (weight ratio) as in Example 3-2. The open circuit voltage in full charge was 4.40 V for each secondary battery. The area density ratio of the cathode active material layer 21B to the anode active material layer 22B was as shown in Table 3, respectively.

In Example 6-3, a secondary battery was fabricated in the same manner as in Example 3-2, except that a mixture of polyvinylidene fluoride with intrinsic viscosity of 3.1 dl/g and polyvinylidene fluoride with intrinsic viscosity of 1.3 dl/g was used in forming the cathode active material layer 21B. The ratio of polyvinylidene fluoride in the cathode mixture was 2.0 wt % for the polyvinylidene fluoride with intrinsic viscosity of 3.1 dl/g, and 1.0 wt % for the polyvinylidene fluoride with intrinsic viscosity of 1.3 dl/g. The open circuit voltage in full charge was 4.40 V. The area density ratio of the cathode active material layer 21B to the anode active material layer 22B was as shown in Table 3.

As Comparative examples 6-1 and 6-2 relative to these examples, secondary batteries were fabricated in the same manner as in Examples 6-1 and 6-2, except that polyvinylidene fluoride with intrinsic viscosity of 1.3 dl/g was used in forming the cathode active material layer 21B.

For the obtained secondary batteries of Examples 6-1 to 6-3 and Comparative examples 6-1 and 6-2, charge and discharge were performed in the same manner as in Example 3-2, and the discharge capacity at the 5th cycle, the discharge capacity retention ratio at the 200th cycle, and the state of the cathode 21 after 200 cycles were examined. Results thereof are shown in Table 3 together with the results of Example 3-2 and Comparative example 3-1.

TABLE 3
Upper limit voltage of charge: 4.40 V

| | | | | | Discharge | |
|---|---|---|---|---|---|---|
| | | | | | capacity | |
| | PVDF | | | Discharge | retention ratio | |
| | Intrinsic | | | capacity at | at the 200th | Cathode after |
| | viscosity | Content | Area density | the 5th cycle | cycle | charge and |
| | (dl/g) | (wt %) | ratio | (mAh/g) | (%) | discharge |
| Example 6-1 | 3.1 | 2.0 | 1.83 | 178 | 80 | ◯ |
| Example 3-2 | 3.1 | 3.0 | 1.86 | 176 | 87 | ◯ |
| Example 6-2 | 3.1 | 4.0 | 1.89 | 174 | 86 | ◯ |
| Example 6-3 | 3.1 | 2.0 | 1.86 | 174 | 85 | ◯ |
| | 1.3 | 1.0 | | | | |
| Comparative | 1.3 | 2.0 | 1.83 | 178 | 65 | X |
| example 6-1 | | | | | | |
| Comparative | 1.3 | 3.0 | 1.86 | 177 | 76 | X |
| example 3-1 | | | | | | |
| Comparative | 1.3 | 4.0 | 1.89 | 175 | 75 | □ |
| example 6-2 | | | | | | |

PVDF: polyvinylidene fluoride

As shown in Table 3, in Examples 3-2, 6-1, and 6-2, in which polyvinylidene fluoride with intrinsic viscosity of 2.0 dl/g or more was used for the cathode active material layer 21B, though the discharge capacity retention ratio was slightly improved when the ratio of polyvinylidene fluoride was increased, major change was not shown after the ratio of polyvinylidene fluoride exceeds a certain amount. Meanwhile, in Comparative examples 3-1, 6-1, and 6-2, in which polyvinylidene fluoride with intrinsic viscosity of under 2.0 dl/g was used, though the characteristics were improved when the ratio of polyvinylidene fluoride was increased, sufficient characteristics could not been obtained. In Comparative example 6-3, in which polyvinylidene fluoride with intrinsic viscosity of under 2.0 dl/g was mixed, sufficient characteristics could be obtained as well.

That is, it was found that when the polymer with intrinsic viscosity of 2.0 dl/g to 10 dl/g which contains vinylidene fluoride as an element was used for the cathode active material layer 21B, separation of the cathode active material layer 21B could be prevented and superior cycle characteristics could be obtained even if the open circuit voltage in full charge was 4.25 V or more.

### EXAMPLES 7-1 TO 7-8

Secondary batteries were fabricated in the same manner as in Example 3-2, except that the ratio between the first cathode material and the second cathode material was changed as shown in Table 4. The area density of the cathode active material layer 21B and the pressure applied by a rolling press machine were identical with that in Example 3-2. The volume density of the cathode active material layer 21B in each Embodiment was as shown in Table 4. When the spirally wound electrode body 20 was formed, the length in the spirally wound direction of the cathode 21 and the anode 22 was adjusted in each Example so that the outer diameter thereof became identical.

For the obtained secondary batteries of Examples 7-1 to 7-8, charge and discharge were performed in the same manner as in Example 3-2, and the discharge capacity at the 5th cycle, the discharge capacity retention ratio at the 200th cycle, and the discharge capacity at the 200th cycle were examined. The discharge capacity was examined for the value per 1 cm³ of the cathode active material layer 21B as well by the formula of (discharge capacity of the battery (mAh)/amount of the cathode active material layer 21B (cm³)). Results thereof are shown in Table 4 together with the results of Example 3-2.

TABLE 4
Upper limit voltage of charge: 4.40 V

| | | | Volume | | | | |
|---|---|---|---|---|---|---|---|
| | | | density of | | | 200th cycle | |
| | | | cathode | | | Discharge | |
| | Cathode material | | active | 5th cycle | | capacity | |
| | | Mixing | material | Discharge | Discharge | retention | Discharge |
| | | amount | layer | capacity | capacity | ratio | capacity |
| | Kind | (wt % | (g/cm³) | (mAh/g) | (mAh/cm³) | (%) | (mAh/cm³) |
| Example | LiCo_{0.98}Al_{0.01}Mg_{0.01}O₂ | 100 | 3.65 | 173 | 631 | 83 | 523 |
| 7-1 | LiNi_{0.5}Co_{0.2}Mn_{0.3}O₂ | 0 | | | | | |
| Example | LiCo_{0.98}Al_{0.01}Mg_{0.01}O₂ | 90 | 3.6 | 174 | 626 | 86 | 538 |
| 7-2 | LiNi_{0.5}Co_{0.2}Mn_{0.3}O₂ | 10 | | | | | |
| Example | LiCo_{0.98}Al_{0.01}Mg_{0.01}O₂ | 80 | 3.6 | 176 | 634 | 87 | 552 |
| 3-2 | LiNi_{0.5}Co_{0.2}Mn_{0.3}O₂ | 20 | | | | | |
| Example | LiCo_{0.98}Al_{0.01}Mg_{0.01}O₂ | 70 | 3.5 | 177 | 619 | 87 | 539 |
| 7-3 | LiNi_{0.5}Co_{0.2}Mn_{0.3}O₂ | 30 | | | | | |
| Example | LiCo_{0.98}Al_{0.01}Mg_{0.01}O₂ | 60 | 3.4 | 178 | 605 | 86 | 520 |
| 7-4 | LiNi_{0.5}Co_{0.2}Mn_{0.3}O₂ | 40 | | | | | |
| Example | LiCo_{0.98}Al_{0.01}Mg_{0.01}O₂ | 50 | 3.35 | 178 | 596 | 85 | 506 |
| 7-5 | LiNi_{0.5}Co_{0.2}Mn_{0.3}O₂ | 50 | | | | | |
| Example | LiCo_{0.98}Al_{0.01}Mg_{0.01}O₂ | 40 | 3.3 | 179 | 591 | 85 | 502 |
| 7-6 | LiNi_{0.5}Co_{0.2}Mn_{0.3}O₂ | 60 | | | | | |
| Example | LiCo_{0.98}Al_{0.01}Mg_{0.01}O₂ | 20 | 3.2 | 182 | 582 | 85 | 495 |
| 7-7 | LiNi_{0.5}Co_{0.2}Mn_{0.3}O₂ | 80 | | | | | |
| Example | LiCo_{0.98}Al_{0.01}Mg_{0.01}O₂ | 0 | 3.15 | 184 | 579 | 80 | 463 |
| 7-8 | LiNi_{0.5}Co_{0.2}Mn_{0.3}O₂ | 100 | | | | | |

As shown in Table 4, according to Examples 7-2 to 7-7 and 3-2, in which the mixture of the first cathode material and the second cathode material was used, the discharge capacity retention ratio could be improved compared to that in Example 7-1 using only the first cathode material. Further, according to Examples 7-2 to 7-7 and 3-2, the volume density of the cathode active material layer 21B could be improved and thereby the discharge capacity per unit volume could be improved compared to that in Example 7-8 using only the second cathode material. That is, it was found that when the mixture of the first cathode material and the second cathode material was used, higher values could be obtained for both the discharge capacity and the discharge capacity retention ratio.

Further, there was a tendency that as the ratio of the first cathode material was lowered, the volume density of the cathode active material layer 21B was lowered and the discharge capacity per unit volume was lowered. That is, it was found that the weight ratio between the first cathode material and the second cathode material (first cathode material:second cathode material) was preferably in the range from 5:5 to 9:1, and more preferably in the range from 7:3 to 9:1.

### EXAMPLES 8-1 TO 8-3

Secondary batteries were fabricated in the same manner as in Example 3-2, except that only the first cathode material was used, and lithium hydroxide (LiOH) and a coprecipitated hydroxide expressed as Co_{0.98}AlₓMg_{y}Zr_{z}(OH₂) (in the formula, 0.98+x+y+z=1) were mixed so that the mol ratio between lithium and the total of other metal elements became Li:(Co+Al+Mg+Zr)=1.1 as shown in Table 5. The volume density of the cathode active material layer 21B in Examples 8-1 to 8-3 is as shown in Table 5.

For the obtained secondary batteries of Examples 8-1 to 8-3, charge and discharge were performed in the same manner as in Example 3-2, and the discharge capacity at the 5th cycle, the discharge capacity retention ratio at the 200th cycle, and the discharge capacity at the 200th cycle were examined. Results thereof are shown in Table 5 together with the results of Example 7-1.

TABLE 5
Upper limit voltage of charge: 4.40 V

| | | | Volume | | | | |
|---|---|---|---|---|---|---|---|
| | | | density of | | | 200th cycle | |
| | | | cathode | | | Discharge | |
| | Cathode material | | active | 5th cycle | | capacity | |
| | | Mixing | material | Discharge | Discharge | retention | Discharge |
| | | amount | layer | capacity | capacity | ratio | capacity |
| | Kind | (wt %) | (g/cm³) | (mAh/g) | (mAh/cm³) | (%) | (mAh/cm³) |
| Example | LiCo_{0.98}Al_{0.01}Mg_{0.01}O₂ | 100 | 3.65 | 173 | 631 | 83 | 523 |
| 7-1 | LiNi_{0.5}Co_{0.2}Mn_{0.3}O₂ | 0 | | | | | |
| Example | LiCo_{0.96}Al_{0.03}Mg_{0.01}O₂ | 100 | 3.65 | 170 | 621 | 88 | 545 |
| 8-1 | LiNi_{0.5}Co_{0.2}Mn_{0.3}O₂ | 0 | | | | | |
| Example | LiCo_{0.98}Al_{0.01}Mg_{0.02}O₂ | 100 | 3.65 | 170 | 621 | 86 | 534 |
| 8-2 | LiNi_{0.33}Co_{0.33}Mn_{0.33}O₂ | 0 | | | | | |
| Example | LiCo_{0.97}Zr_{0.01}Al_{0.01}Mg_{0.01}O₂ | 100 | 3.65 | 172 | 628 | 84 | 527 |
| 8-3 | LiNi_{0.5}Co_{0.2}Mn_{0.3}O₂ | 0 | | | | | |

As shown in Table 5, it was found that according to the examples using only the first cathode material, the discharge capacity retention ratio could be improved in Examples 8-1 to 8-2, in which the mol ratio of Al and Mg was higher compared to that in Example 7-1. That is, it was found that the mol ratio of Al and Mg was preferably high, and the mol ratio of Al was preferably contained higher than that of Mg.

### EXAMPLE 9-1

A secondary battery was fabricated in the same manner as in Example 3-2, except that the average composition of the second cathode material was LiNi_{0.33}Co_{0.33}Mn_{0.33}O₂. The mol ratio among nickel, cobalt, and manganese in the second cathode material was 1:1:1. The second cathode material was formed by mixing lithium hydroxide and a coprecipitated hydroxide expressed as Ni_{0.33}Co_{0.33}Mn_{0.33}(OH)₂ so that the mol ratio between lithium and the total of other metal elements became Li:(Ni+Co+Mn)=1:1, heat treating a mixture thereof for 20 hours at 1000 deg C. in the air, and then pulverizing the mixture. The specific surface area by BET of the pulverized second cathode material was 0.42 m²/g, and the average particle diameter was 10.3 μm. For the second cathode material, X-ray diffraction measurement by CuKα was performed. It was confirmed that the second cathode material also had a bedded salt structure of R-3m rhombohedron. The volume density of the cathode active material layer 21B in Example 9-1 is as shown in Table 6.

For the obtained secondary battery of Example 9-1, charge and discharge were performed in the same manner as in Example 3-2, and the discharge capacity at the 5th cycle, the discharge capacity retention ratio at the 200th cycle, and the discharge capacity at the 200th cycle were examined. Results thereof are shown in Table 6 together with the results of Examples 3-2, 7-1, and 7-8.

TABLE 6
Upper limit voltage of charge: 4.40 V

| | | | Volume | | | | |
|---|---|---|---|---|---|---|---|
| | | | density of | | | 200th cycle | |
| | | | cathode | | | Discharge | |
| | Cathode material | | active | 5th cycle | | capacity | |
| | | Mixing | material | Discharge | Discharge | retention | Discharge |
| | | amount | layer | capacity | capacity | ratio | capacity |
| | Kind | (wt %) | (g/cm³) | (mAh/g) | (mAh/cm³) | (%) | (mAh/cm³) |
| Example | LiCo_{0.98}Al_{0.01}Mg_{0.01}O₂ | 100 | 3.65 | 173 | 631 | 85 | 536 |
| 7-1 | LiNi_{0.5}Co_{0.2}Mn_{0.3}O₂ | 0 | | | | | |
| Example | LiCo_{0.98}Al_{0.01}Mg_{0.01}O₂ | 80 | 3.6 | 176 | 634 | 87 | 552 |
| 3-2 | LiNi_{0.5}Co_{0.2}Mn_{0.3}O₂ | 20 | | | | | |
| Example | LiCo_{0.98}Al_{0.01}Mg_{0.01}O₂ | 80 | 3.6 | 175 | 630 | 87 | 548 |
| 9-1 | LiNi_{0.33}Co_{0.33}Mn_{0.33}O₂ | 20 | | | | | |
| Example | LiCo_{0.98}Al_{0.01}Mg_{0.01}O₂ | 0 | 3.15 | 184 | 579 | 84 | 486 |
| 7-8 | LiNi_{0.5}Co_{0.2}Mn_{0.3}O₂ | 100 | | | | | |

As shown in Table 6, in Example 9-1, results equal to that in other examples could be obtained. That is, it was found that when other cathode material was used, similar results could be obtained.

### EXAMPLES 10-1 TO 10-3

Secondary batteries were fabricated in the same manner as in Examples 8-1 to 8-3, except that the first cathode material and the second cathode material were used, and the ratio between the first cathode material and the second cathode material was 8:2. The volume density of the cathode active material layer 21B in Examples 10-1 to 10-3 is as shown in Table 7.

For the obtained secondary batteries of Examples 10-1 to 10-3, charge and discharge were performed in the same manner as in Example 3-2, and the discharge capacity at the 5th cycle, the discharge capacity retention ratio at the 200th cycle, and the discharge capacity at the 200th cycle were examined. Results thereof are shown in Table 7 together with the results of Example 3-2.

TABLE 7
Upper limit voltage of charge: 4.40 V

| | | | Volume | | | | |
|---|---|---|---|---|---|---|---|
| | | | density of | | | 200th cycle | |
| | | | cathode | | | Discharge | |
| | Cathode material | | active | 5th cycle | | capacity | |
| | | Mixing | material | Discharge | Discharge | retention | Discharge |
| | | amount | layer | capacity | capacity | ratio | capacity |
| | Kind | (wt %) | (g/cm³) | (mAh/g) | (mAh/cm³) | (%) | (mAh/cm³) |
| Example | LiCo_{0.98}Al_{0.01}Mg_{0.01}O₂ | 80 | 3.6 | 176 | 634 | 87 | 552 |
| 3-2 | LiNi_{0.5}Co_{0.2}Mn_{0.3}O₂ | 20 | | | | | |
| Example | LiCo_{0.96}Al_{0.03}Mg_{0.01}O₂ | 80 | 3.6 | 173 | 623 | 89 | 555 |
| 10-1 | LiNi_{0.5}Co_{0.2}Mn_{0.3}O₂ | 20 | | | | | |
| Example | LiCo_{0.97}Al_{0.01}Mg_{0.02}O₂ | 80 | 3.6 | 172 | 619 | 88 | 544 |
| 10-2 | LiNi_{0.33}Co_{0.33}Mn_{0.33}O₂ | 20 | | | | | |
| Example | LiCo_{0.97}Zr_{0.01}Al_{0.01}Mg_{0.01}O₂ | 80 | 3.6 | 174 | 626 | 84 | 526 |
| 10-3 | LiNi_{0.5}Co_{0.2}Mn_{0.3}O₂ | 20 | | | | | |

As shown in Table 7, according to Examples 10-1 to 10-2, in which the mol ratio of Al and Mg was high, the discharge capacity retention ratio could be improved compared to that in Example 3-2.

### EXAMPLES 11-1 TO 11-3

Secondary batteries were fabricated in the same manner as in Example 3-2, except that the surface density ratio of the cathode active material layer 21B to the anode active material layer 22B was changed as shown in Table 8. For the obtained secondary batteries of Examples 11 -1 to 11-3, charge and discharge were performed in the same manner as in Example 3-2, and the discharge capacity at the 5th cycle and the discharge capacity retention ratio at the 200th cycle were examined. Results thereof are shown in Table 8 together with the results of Example 3-2.

TABLE 8
Upper limit voltage of charge: 4.40 V

| | | | Filling amount | | Discharge |
|---|---|---|---|---|---|
| | Intrinsic | | of cathode | Discharge | capacity |
| | viscosity of | | material | capacity at the | retention ratio at |
| | PVDF | Area density | (absolute | 5th cycle | the 200th cycle |
| | (dl/g) | ratio | value□ | (mAh/g) | (%) |
| Example 3-2 | 3.1 | 1.86 | 100 | 176 | 87 |
| Example 11-1 | 3.1 | 1.77 | 95 | 176 | 87 |
| Example 11-2 | 3.1 | 1.72 | 93 | 176 | 87 |
| Example 11-3 | 3.1 | 1.68 | 89 | 175 | 86 |

PVDF: polyvinylidene fluoride

As shown in Table 8, there was a tendency that as the surface density ratio of the cathode active material layer 21B to the anode active material layer 22B was lowered, the amount of the cathode material filled in the battery was decreased and the battery capacity was lowered. That is, it was found that the surface density ratio of the cathode active material layer 21B to the anode active material layer 22B was preferably 1.70 or more.

### EXAMPLES 12-1 AND 12-2

Secondary batteries were fabricated in the same manner as in Example 3-2, except that the structure of the separator 23 was changed. For the separator 23, a monolayer film made of polyethylene was used in Example 12-1 and a three-layer separator (PP/PE/PP) made of polypropylene for the surface and polyethylene for the inside was used in Example 12-2. The separator 23 was 20 μm thick for the both examples.

As Comparative examples 12-1 and 12-2 relative to these examples, secondary batteries were fabricated in the same manner as in Example 12-1 or Example 3-2, except that the amounts of the cathode material and the anode material were adjusted so that the open circuit voltage in full charge was 4.20 V.

For the obtained secondary batteries of Examples 12-1, 12-2 and Comparative examples 12-1, 12-2, charge and discharge were performed in the same manner as in Example 3-2, and the discharge capacity at the 5th cycle, the discharge capacity retention ratio at the 200th cycle, and the discharge capacity at the 200th cycle were examined. Results thereof are shown in Table 9 together with the results of Example 3-2.

0122

Cathode material: LiCo_{0.98}Al_{0.01}Mg_{0.01}O₂ + LiNi_{0.5}Co_{0.2}Mn_{0.3}O₂

| | | | | | 200th cycle | |
|---|---|---|---|---|---|---|
| | Upper limit | | | Discharge | Discharge | |
| | voltage of | Separator | | capacity at | capacity | Discharge |
| | charge | | Thickness | the 5th cycle | retention ratio | capacity |
| | (V) | Kind | (μm) | (mAh/g) | (%) | (mAh/cm³) |
| Example 12-1 | 4.40 | PE | 20 | 178 | 80 | 512 |
| Example 3-2 | | PP/PE/PP | 20 | 176 | 87 | 551 |
| Example 12-2 | | PP/PE/PP | 20 | 175 | 87 | 548 |
| Comparative | 4.20 | PE | 20 | 157 | 91 | 519 |
| example 12-1 | | | | | | |
| Comparative | | PP/PE/PP | 20 | 156 | 91 | 511 |
| example 12-2 | | | | | | |

PE: polyethylene
PP: polypropylene

As shown in Table 9, when the open circuit voltage in full charge was higher than 4.20 V, a higher capacity retention ratio could be obtained in Examples 12-2 and 3-2 using the three-layer separator (PP/PE/PP) made of polypropylene for the surface and polyethylene for the inside than that in Example 12-1 using the monolayer film made of polyethylene. Meanwhile, there was no difference between examples 12-1 and 12-2, in which the open circuit voltage in full charge was 4.20 V.

That is, it was found that in the battery in which the open circuit voltage in full charge was higher than 4.20 V, at least part of the cathode 21 side of the separator 23 was preferably made of polypropylene.

### EXAMPLES 13-1 AND 13-2

Secondary batteries were fabricated in the same manner as in Example 3-2, except that the structure of the anode 22 was changed. In Example 13-1, the anode 22 was formed in the same manner as in Example 1-2, except that copper-tin alloy composed of 55 wt % of copper and 45 wt % of tin was used as an anode material. In Example 13-2, the anode 22 was formed by forming the anode active material layer 22B made of silicon being 5.0 μm thick on the anode current collector 22A by sputtering.

As Comparative examples 13-1 and 13-2 relative to Examples 13-1 and 13-2, secondary batteries were fabricated in the same manner as in Example 13-1 or Example 13-2, except that polyvinylidene fluoride with intrinsic viscosity of 1.3 dl/g was used in forming the cathode active material layer.

For the obtained secondary batteries of Examples 13-1, 13-2 and Comparative examples 13-1, 13-2, charge and discharge were performed in the same manner as in Example 3-2, and the discharge capacity at the 5th cycle, the discharge capacity retention ratio at the 200th cycle, and separation states of the cathode active material layer 21B were examined. Results thereof are shown in Table 10 together with the results of Example 3-2 and Comparative example 3-1.

TABLE 10
Cathode material: LiCo_{0.98}Al_{0.01}Mg_{0.01}O₂ + LiNi_{0.5}Co_{0.2}Mn_{0.3}O₂

| | | | | | Discharge | |
|---|---|---|---|---|---|---|
| | | | | Discharge | capacity | |
| | Upper limit | Intrinsic | | capacity at | retention ratio | Cathode after |
| | voltage of | viscosity of | Anode | the 5th cycle | at the 200th | charge and |
| | charge (V) | PVDF (dl/g) | material | (mAh/g) | cycle (%) | discharge |
| le 3-2 | 4.40 | 3.1 | Artificial | 176 | 87 | ◯ |
| | | | graphite | | | |
| Example 13-1 | | | Cu—Sn | 177 | 84 | ◯ |
| Example 13-2 | | | Si | 176 | 73 | ◯ |
| Comparative | 4.40 | 1.3 | Artificial | 177 | 76 | X |
| example 3-1 | | | graphite | | | |
| Comparative | | | Cu—Sn | 176 | 73 | X |
| example 13-1 | | | | | | |
| Comparative | | | Si | 175 | 65 | X |
| example 13-2 | | | | | | |

polyvinylidene fluoride

As shown in Table 10, it was found that when the polymer with intrinsic viscosity of 2.0 dl/g to 10 dl/g which contains vinylidene fluoride as an element was used for the cathode active material layer 21B, separation of the cathode active material layer 21B could be small and a high value could be obtained for the discharge capacity retention ratio even if other anode material was used.

The invention has been described with reference to the embodiments and the examples. However, the invention is not limited to the foregoing embodiments and the foregoing examples, and various modifications may be made. For example, in the foregoing embodiments and the foregoing examples, descriptions have been given of the secondary battery having the spirally wound structure. However, the invention can be similarly applied to a secondary battery having a structure in which a cathode and an anode are folded or a secondary battery having a structure in which a cathode and an anode are layered. In addition, the invention can be applied to a secondary battery such as a so-called coin type secondary battery, a button type secondary battery, and a square type secondary battery.

Further, in the foregoing embodiments and the foregoing examples, descriptions have been given of the case using an electrolytic solution or a gelatinous electrolyte. However, the invention can be also applied to the case using other electrolyte.

Further, in the foregoing embodiments and the foregoing examples, descriptions have been given of the case in which the anode material capable of inserting and extracting lithium (Li) is used as an anode active material, and the anode capacity is expressed by the capacity component due to insertion and extraction of lithium (Li). However, the invention can be also applied to a battery in which lithium metal is used as an anode active material and the anode capacity is expressed by the capacity component due to precipitation and dissolution of the lithium metal, or a battery in which an anode material capable of inserting and extracting lithium (Li) and lithium metal are used as an anode active material, the anode capacity includes the capacity component due to insertion and extraction of lithium (Li) and the capacity component due to precipitation and dissolution of lithium metal, and the anode capacity is expressed by a sum thereof.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A battery comprising a cathode and an anode oppositely arranged with an electrolyte and a separator in between,
wherein an open circuit voltage in a full charge state per a pair of the cathode and the anode from 4.25 V to 6.00 V,
the cathode has a structure that a cathode active material layer including a cathode active material and a binder is provided on a cathode current collector, and
the binder contains a polymer with an intrinsic viscosity of 2.0 dl/g to 10 dl/g and which contains vinylidene fluoride as an element.

2. The battery according to claim 1, wherein the intrinsic viscosity of the polymer ranges from 2.5 dl/g to 5.5 dl/g.

3. The battery according to claim 1, wherein the cathode active material layer contains at least one of a first cathode material having an average composition shown below in Chemical formula 1 and a second cathode material having an average composition shown below in Chemical formula 2:
LiₐCo_{1-b}M1_{b}O_{2-c} Chemical formula 1
where M1 represents at least one selected from the group consisting of manganese (Mn), nickel (Ni), magnesium (Mg), aluminum (Al), boron (B), titanium (Ti), vanadium (V), chromium (Cr), iron (Fe), copper (Cu), zinc (Zn), gallium (Ga), yttrium (Y), zirconium (Zr), niobium (Nb), molybdenum (Mo), tin (Sn), calcium (Ca), strontium (Sr), and tungsten (W); and a, b, and care values in the range of 0.9≦a≦1.1, 0≦b≦0.3, and −0.1≦c≦0.1
Li_{w}NiₓCo_{y}Mn_{z}M2_{1-x-y-z}O₂₋ᵥ Chemical formula 2
where M2 represents at least one selected from the group consisting of magnesium (Mg), aluminum (Al), boron (B), titanium (Ti), vanadium (V), chromium (Cr), iron (Fe), copper (Cu), zinc (Zn), gallium (Ga), yttrium (Y), zirconium (Zr), niobium (Nb), molybdenum (Mo), tin (Sn), calcium (Ca), strontium (Sr), and tungsten (W); and v, w, x, y, and z are values in the range of −0.1≦v≦0.1, 0.9≦w≦1.1, 0<x<1, 0<y<0.7, 0<z<0.5, and 0≦1-x-y-z≦0.2.

4. The battery according to claim 3, wherein a weight ratio between the first cathode material and the second cathode material ranges from 5:5 to 10:0.

5. The battery according to claim 1, wherein the anode has a structure in which an anode active material layer containing a carbon material as an anode active material is provided on an anode current collector, and a surface density ratio of the cathode active material layer to the anode active material layer ranges from 1.70 to 2.10.

6. The battery according to claim 1, wherein at least part of a cathode portion of the separator is made of at least one of polyvinylidene fluoride and polypropylene.

7. The battery according to claim 1, wherein the electrolyte contains vinylene carbonate.
